(19) United States
(12) Patent Application Publication
(10) Pub. No.: US 2025/0072316 A1
(43) Pub. Date: Mar. 6, 2025

(54) AGRICULTURAL LIQUID INJECTION SYSTEM

(71) Applicant: CNH Industrial America LLC, New Holland, PA (US)

(72) Inventor: David Long, Washington, IL (US)

(21) Appl. No.: 18/240,117

(22) Filed: Aug. 30, 2023

(51) Int. Cl. A01C 23/02; A01B 79/00; A01C 23/00; A01C 23/04

(52) U.S. Cl. CPC A01C 23/024; A01B 79/005; A01C 23/007; A01C 23/025; A01C 23/047

(57) ABSTRACT

An agricultural implement includes a ground engaging tool. The agricultural implement also includes a liquid injection system having a liquid injection conduit and a liquid injection outlet passage. The liquid injection outlet passage is fluidly coupled to the liquid injection conduit. The liquid injection outlet passage is configured to output a jet of a liquid toward soil to inject the liquid into the soil at a liquid location behind the ground engaging tool relative to a direction of travel of the agricultural implement. The agricultural implement also includes an anhydrous ammonia application system having an anhydrous ammonia application conduit and an anhydrous ammonia application outlet passage. The anhydrous ammonia application outlet passage is fluidly coupled to the anhydrous ammonia application conduit. The anhydrous ammonia application outlet passage is configured to apply the anhydrous ammonia to the soil at an anhydrous ammonia location behind the ground engaging tool relative to the direction of travel of the agricultural implement.

### BACKGROUND

The present disclosure relates to an agricultural liquid injection system.

Certain agricultural implements are used for supplying nitrogen to soil within a field. Anhydrous ammonia (NH₃) is an inorganic compound commonly used for increasing the nitrogen content of the soil. Anhydrous ammonia is stored as a liquid, but quickly turns into a gas when released into the soil. Due to the gaseous nature of anhydrous ammonia when applied to the soil, a significant portion of the anhydrous ammonia applied to the field is not retained in the soil, but is instead dispersed into the air, thereby reducing the efficiency of the fertilizer application process.

### BRIEF DESCRIPTION

In certain embodiments, an agricultural implement includes a ground engaging tool. The agricultural implement also includes a liquid injection system having a liquid injection conduit and a liquid injection outlet passage. The liquid injection outlet passage is fluidly coupled to the liquid injection conduit. The liquid injection outlet passage is configured to output a jet of a liquid toward soil to inject the liquid into the soil at a liquid location behind the ground engaging tool relative to a direction of travel of the agricultural implement. The agricultural implement also includes an anhydrous ammonia application system having an anhydrous ammonia application conduit and an anhydrous ammonia application outlet passage. The anhydrous ammonia application outlet passage is fluidly coupled to the anhydrous ammonia application conduit. The anhydrous ammonia application outlet passage is configured to apply the anhydrous ammonia to the soil at an anhydrous ammonia location behind the ground engaging tool relative to the direction of travel of the agricultural implement.

### DRAWINGS

These and other features, aspects, and advantages of the present disclosure will become better understood when the following detailed description is read with reference to the accompanying drawings in which like characters represent like parts throughout the drawings, wherein:

FIG. 1 is a perspective view of an embodiment of an agricultural implement having a liquid injection system and an anhydrous ammonia application system;

FIG. 2 is a perspective view of a portion of the agricultural implement of FIG. 1, in which the agricultural implement includes a ground engaging tool, an anhydrous ammonia application outlet passage of the anhydrous ammonia application system disposed behind the ground engaging tool, and a liquid injection outlet passage of the liquid injection system disposed behind the anhydrous ammonia application outlet passage; and

FIG. 3 is a schematic view of an embodiment of a control system that may be employed to control the liquid injection system and the anhydrous ammonia application system of FIG. 1.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

The process of farming may include applying a nitrogen-rich fertilizer, such as anhydrous ammonia (NH₃), to soil in a field. An implement towed by a work vehicle may be used for applying anhydrous ammonia. The implement may be equipped with storage tanks for storing the anhydrous ammonia and for storing a liquid (e.g., water) to be injected into the soil while the anhydrous ammonia is applied. The anhydrous ammonia may react with the liquid to form an ammonia solution with a significantly lower vapor pressure than the anhydrous ammonia, thereby increasing the amount of nitrogen retained by the soil. The implement may also be equipped with one or more ground engaging tools (e.g., coulters, knives) each configured to form a trench in the soil. The implement and/or the work vehicle may be at least partially automated to apply the anhydrous ammonia and/or inject the liquid into the soil. In certain embodiments disclosed herein, the implement may include one or more ground engaging tools, an anhydrous ammonia application system, and a liquid injection system. The anhydrous ammonia application system may include an anhydrous ammonia application conduit coupled to an anhydrous ammonia application outlet passage. The anhydrous ammonia application outlet passage may be configured to apply the anhydrous ammonia to the soil at an anhydrous ammonia location behind the ground engaging tool. The liquid injection system may include a liquid injection conduit coupled to a liquid injection outlet passage. The liquid injection outlet passage may be configured to output a jet of the liquid toward the soil to inject the liquid into the soil at a liquid location behind the anhydrous ammonia location and, in certain embodiments, in front of the ground engaging tool.

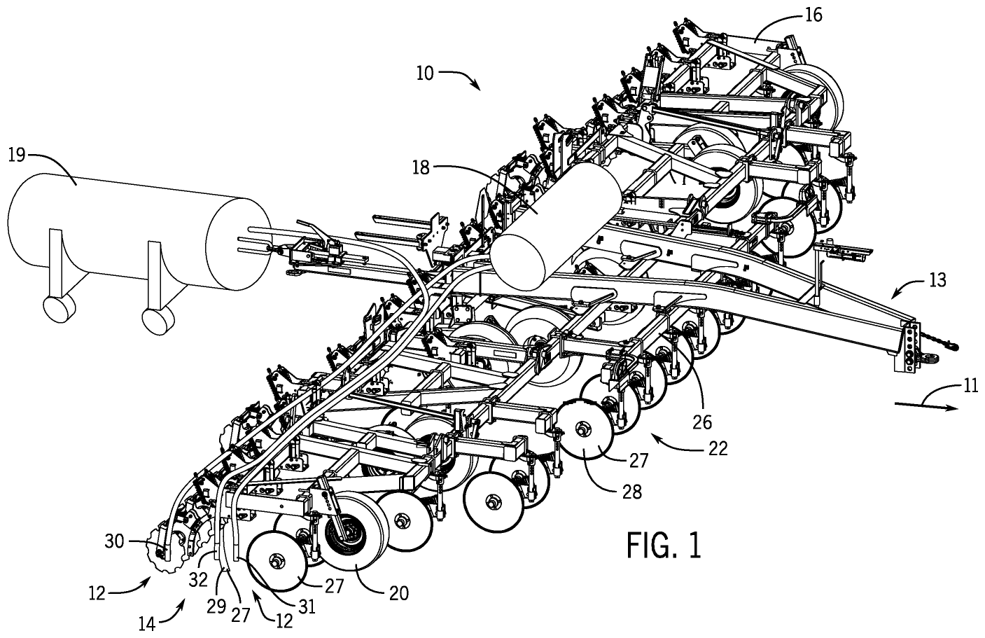

FIG. 1 is a perspective view of an embodiment of an agricultural implement 10 having a liquid injection system 12 and an anhydrous ammonia application system 14. In the illustrated embodiment, the agricultural implement 10 is configured to be towed along a direction of travel 11 by a work vehicle, such as a tractor or other prime mover. The work vehicle may be coupled to the agricultural implement 10 by a hitch assembly 13, such as the illustrated “goose neck” pull frame. As illustrated, the hitch assembly 13 is coupled to a frame assembly 16 of the agricultural implement 10 to facilitate towing of the agricultural implement 10 in the direction of travel 11. In the illustrated embodiment, the frame assembly 16 supports a liquid storage tank 18 configured to house a liquid (e.g., water). As shown, the agricultural implement 10 is configured to tow an anhydrous ammonia storage tank 19 configured to house anhydrous ammonia. Wheels 20 coupled to the frame assembly 16 are configured to support the weight of the frame assembly 16, the storage tanks 18 and 19, the liquid, and the anhydrous ammonia, thereby enabling the agricultural implement 10 to be towed across the field.

The liquid injection system 12 is configured to transfer the liquid from the liquid storage tank 18 to multiple row units 22 mounted to one or more tool bars 26 of the frame assembly 16. In the illustrated embodiment, each row unit 22 includes ground engaging tool(s) 27, which may include a coulter disc 28 (e.g., disc blade) configured to break the soil and/or a knife 29 configured to form a trench in the soil. In certain embodiments, the knife 29 may be omitted. The row unit 22 also includes a liquid injection outlet passage 30 (e.g., including an injection nozzle) of the liquid injection system 12 configured to output a jet of the liquid from the storage tank 18 toward the soil to deposit (e.g., inject) the liquid into the soil. In certain embodiments, the row unit 22 also includes an additional liquid injection outlet passage 31 of the liquid injection system 12 configured to output a jet of the liquid from the storage tank 18 toward the soil. In addition, the row unit 22 includes an anhydrous ammonia application outlet passage 32 (e.g., including an applicator nozzle) of the anhydrous ammonia application system 14 configured to apply the anhydrous ammonia from the storage tank 19 to the soil. The liquid injection system 12 and the anhydrous ammonia application system 14 are discussed in more detail herein.

While the illustrated agricultural implement 10 includes a certain number of row units 22, in other embodiments, the agricultural implement may include more or fewer row units. In addition, the number of row units and the spacing between row units may be particularly selected to correspond to the arrangement of row units on respective seeding or planting implements. For example, the agricultural implement 10 may include 25 row units 22 spaced 30 inches from one another. Accordingly, as the agricultural implement 10 is towed across a field, the row units 22 may deposit liquid and anhydrous ammonia in rows having 30-inch spacing. After the liquid and anhydrous ammonia are deposited, a seeding or planting implement (e.g., having row units spaced 30 inches from one another) may deposit seeds between the rows of liquid/anhydrous ammonia (e.g., at the approximate midpoint between rows), thereby facilitating enhanced crop development. In addition, the agricultural implement 10 may be utilized to deposit liquid/anhydrous ammonia to previously planted seeds (e.g., via injecting liquid/anhydrous ammonia between rows of the previously planted seeds).

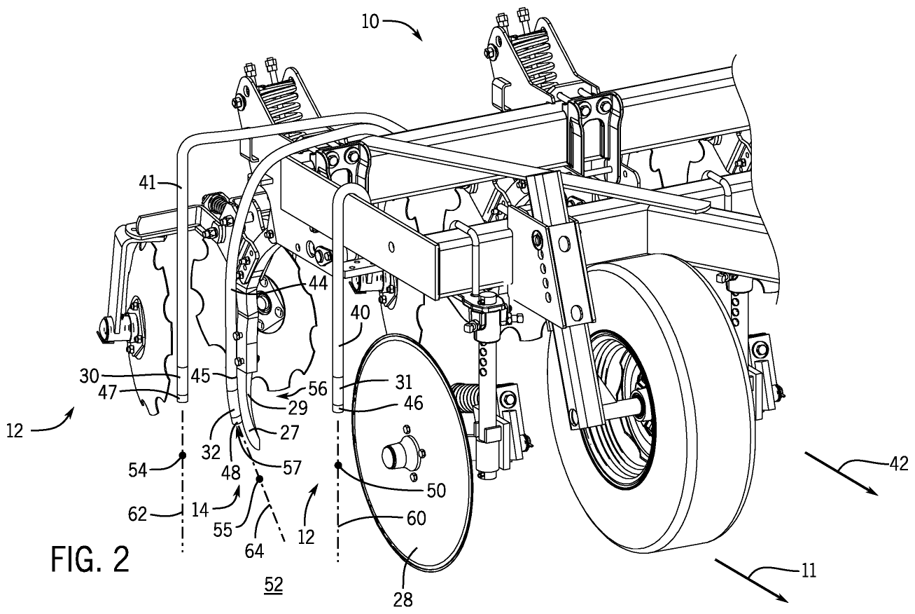

FIG. 2 is a perspective view of a portion of the agricultural implement 10 of FIG. 1, in which the agricultural implement 10 includes a ground engaging tool 27 (e.g. knife 29), an anhydrous ammonia application outlet passage 32 of the anhydrous ammonia application system 14 disposed behind the knife 29, and the liquid injection outlet passage 30 of the liquid injection system disposed behind the anhydrous ammonia application outlet passage 32. The anhydrous ammonia application outlet passage 32 is fluidly coupled to the anhydrous ammonia application conduit 44. In the illustrated embodiment, the anhydrous ammonia application outlet passage 32 is coupled to a rear side 45 of the knife 29 with respect to the longitudinal axis 42 of the agricultural implement 10. In certain embodiments, the anhydrous ammonia application outlet passage 32 may extend below a soil surface 52.

In the liquid injection system 12 includes a liquid injection conduit 41, and the liquid injection outlet passage 30 is fluidly coupled to the liquid injection conduit 41. The liquid injection outlet passage 30 is offset from the knife 29 with respect to a longitudinal axis 42 of the agricultural implement 10 (e.g., along the direction of travel 11 of the agricultural implement 10). In the illustrated embodiment, the liquid injection outlet passage 30 is disposed behind the knife 29 and behind the anhydrous ammonia application outlet passage 32 relative to the direction of travel 11. In the illustrated embodiment, the liquid injection system 12 includes an additional liquid injection conduit 40 fluidly coupled to an additional liquid injection outlet passage 31 disposed in front of the knife 29 relative to the direction of travel 11. In certain embodiments, the liquid injection conduit 41 or the additional liquid injection conduit 40 and the additional liquid injection outlet passage 31 may be omitted. That is, the liquid injection system 12 may include the additional liquid injection conduit 40 disposed in front of the knife 29, but may not include the liquid injection conduit 41 disposed behind the knife, or vice versa. In certain embodiments, the liquid injection system 12 may include two or more anhydrous ammonia application outlet passages 31 disposed behind the knife 29 and in front of the liquid injection outlet passage 30.

In certain embodiments, the liquid injection outlet passage 30 may include a liquid injection nozzle 47, the additional liquid injection outlet passage 31 may include a liquid injection nozzle 46, and the anhydrous ammonia application outlet passage 32 may include an anhydrous ammonia application nozzle 48. The liquid injection outlet passage 30 is configured to output a jet of the liquid toward the soil 52 to inject the liquid into the soil 52 at a liquid location 54. The additional liquid injection outlet passage 31 is configured to output a jet of the liquid toward the soil 52 to inject the liquid into the soil 52 at an additional liquid location 50. The anhydrous ammonia application outlet passage 32 is configured to apply the anhydrous ammonia to the soil 52 at an anhydrous ammonia location 55.

In certain embodiments, the locations 54 and 55 are offset from the knife 29 with respect to the longitudinal axis 42. In the illustrated embodiment, the liquid location 54 is behind the knife 29 and the anhydrous ammonia location 55 relative to the direction of travel 11. The anhydrous ammonia application outlet passage 32 may apply the anhydrous ammonia to the soil 52 along the path traversed by the knife 29. In this manner, the knife 29 may form a trench, and the anhydrous ammonia may be applied into the trench. The liquid injection outlet passage 30 may inject the liquid into the trench behind the anhydrous ammonia, after the anhydrous ammonia has been applied to the trench.

In certain embodiments, the additional liquid injection outlet passage 31 may be disposed on the front side 56 of the knife 29. In this manner, the additional liquid injection outlet passage 31 may inject the liquid into the soil 52 at the liquid location 50 in front of the knife 29 relative to the direction of travel 11. Accordingly, the additional liquid injection outlet passage 31 may inject the liquid into the soil 52 in front of the trench, prior to the knife 29 forming the trench. In certain embodiments, the liquid location 50 or the liquid location 54 may be omitted, based on the liquid injection system 12 including or not including the liquid injection conduit 41 or the additional liquid injection conduit 40 as discussed herein.

In the illustrated embodiment, a central axis 62 of the liquid injection outlet passage 30 and a central axis 64 of the anhydrous ammonia application outlet passage 32 are directed to the locations 54 and 55, respectively. In the illustrated embodiment, the central axes 62 and 64 are shown as being angled relative to each other, though in certain embodiments, the central axes 62 and 64 may be substantially parallel. In certain embodiments, an angle of at least one of the central axes 62 and 64 (e.g., liquid injection outlet passage 30 and/or anhydrous ammonia application outlet passage 32) may be adjustable via actuator(s) (e.g., hydraulic cylinder(s), electric linear actuator(s), etc.) and/or via manual controls (e.g., lever(s), pin/aperture system(s), etc.). In the illustrated embodiment, a central axis 60 of the additional liquid injection outlet passage 31 is directed to the additional liquid location 50. In the illustrated embodiment, the central axes 60 and 62 are shown as being substantially parallel to each other. In certain embodiments, the central axes 60 and 62 may be angled relative to one another.

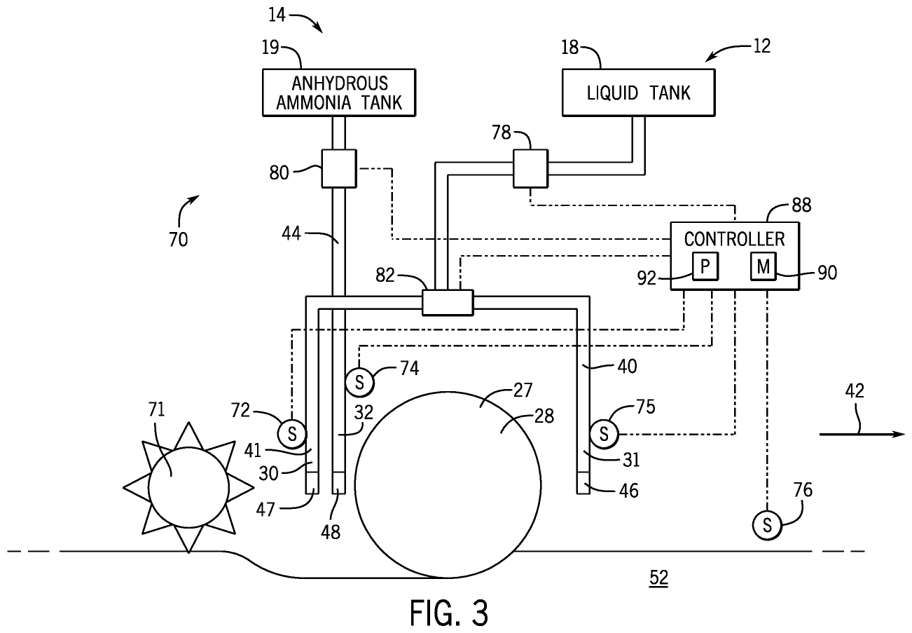

FIG. 3 is a schematic view of an embodiment of a control system 70 that may be employed to control the liquid injection system 12 and the anhydrous ammonia application system 14 of FIG. 1. As shown in the illustrated embodiment, the liquid injection conduit 41 and the anhydrous ammonia application conduit 44 are fluidly coupled to the liquid storage tank 18 and the anhydrous ammonia storage tank 19, respectively. In the illustrated embodiment, the anhydrous ammonia application conduit 44 is fluidly coupled to the anhydrous ammonia application outlet passage 32, which is disposed behind the ground engaging tool 27 (e.g., coulter disc 28) and in front of a spiked disc 71 of the agricultural implement relative to the longitudinal direction 42. Additionally, the liquid injection conduit 41 is fluidly coupled to the liquid injection outlet passage 30, and is disposed longitudinally behind the coulter disc 28 and longitudinally behind the anhydrous ammonia application outlet passage 32 and in front of the spiked disc 71. In certain embodiments, the additional liquid injection conduit 40 is fluidly coupled to the liquid injection outlet passage 31, and is disposed longitudinally in front of the coulter disc 28.

In certain embodiments, the control system 70 includes a flow sensor 72 (e.g., flow meter) fluidly coupled to the liquid injection conduit 41 and configured to output a signal indicative of a flowrate of the liquid through the liquid injection conduit 41. In certain embodiments, the control system 70 includes a flow sensor 74 (e.g., flow meter) coupled to the anhydrous ammonia application conduit 44 and configured to output a signal indicative of a flowrate of anhydrous ammonia through the anhydrous ammonia application conduit 44. In certain embodiments, the control system 70 includes a flow sensor 75 (e.g., flow meter) coupled to the additional liquid injection conduit 40 and configured to output a signal indicative of a flowrate of the liquid through the additional liquid injection conduit 40. Furthermore, in certain embodiments, the control system 70 includes a soil moisture sensor 76 (e.g., soil tension sensor) configured to output a signal indicative of a soil moisture value (e.g., volumetric water content, soil tension, etc.) of the soil 52. In certain embodiments, the control system 70 includes a liquid injection valve 78 fluidly coupled to the additional liquid injection conduit 40 and the liquid injection conduit 41, and the control system 70 includes an anhydrous ammonia application valve 80 fluidly coupled to the anhydrous ammonia application conduit 44. The liquid injection valve 78 is configured to adjust the flowrate of the liquid through the additional liquid injection conduit 40 and/or the liquid injection conduit 41, and the anhydrous ammonia application valve 80 is configured to adjust the flow rate of the anhydrous ammonia through the anhydrous ammonia application conduit 44. In certain embodiments, the flow sensor 75 may be omitted.

In certain embodiments, the control system 70 includes a valve 82 configured to fluidly couple the liquid injection conduit 41 with the additional liquid injection conduit 40 disposed in front of the ground engaging tool 27. The valve 82 may be configured to divert the liquid to the additional liquid injection conduit 40 in addition to the liquid injection conduit 41.

In the illustrated embodiment, the control system 70 includes the controller 88, which is communicatively coupled to the valves 78 and 80, the valve 82, the flow sensors (e.g., flow sensors 72, 74, and 75), and the soil moisture sensor 76. In certain embodiments, the controller 88 is configured to receive signals (e.g., sensor data) from the flow sensors 72, 74, and 75 indicative of flowrates through the liquid injection conduit 41, the anhydrous ammonia application conduit 44, and the additional liquid injection conduit 40, respectively. In certain embodiments, the controller 88 is configured to receive a signal from the soil moisture sensor 76 indicative of the moisture the soil 52. In certain embodiments, the controller 88 is configured to determine flowrates through the liquid injection conduit 41, the anhydrous ammonia application conduit 44, and the additional liquid injection conduit 40, based on the signals received from the flow sensors 72, 74, and 75, respectively. In certain embodiments, the controller 88 is configured to determine a soil moisture value based on the signal received from the soil moisture sensor 76. Furthermore, in certain embodiments, the controller 88 is configured to determine a target flowrate for the liquid, a target flowrate for the anhydrous ammonia, or a combination thereof, based on the soil moisture value. The controller 88 may also be configured to control the liquid injection valve 78 based on the determined flowrate of the liquid and the target flowrate for the liquid (e.g., such that the determined flow rate is within a threshold range of the target flow rate). Additionally or alternatively, the controller 88 may be configured to control the anhydrous ammonia application valve 80 based on the determined flowrate of the anhydrous ammonia and the target flowrate for the anhydrous ammonia (e.g., such that the determined flow rate is within a threshold range of the target flow rate). The controller 88 may also be configured to control the valve 82 based on an input received from an input device (e.g., button, user interface).

In certain embodiments, the controller 88 may also be configured to control the liquid injection valve 78 based on a determined pressure of the liquid and a target pressure for the liquid (e.g., such that the determined pressure is within a threshold range of the target pressure). Additionally or alternatively, the controller 88 may be configured to control the anhydrous ammonia application valve 80 based on a determined pressure of the anhydrous ammonia and a target pressure for the anhydrous ammonia (e.g., such that the determined pressure is within a threshold range of the pressure). In certain embodiments, a pump may be used in conjunction with the liquid injection valve 78 to control the pressure of the liquid. Additionally or alternatively, a pump may be used in conjunction with the anhydrous ammonia application valve 80 to control the pressure of the anhydrous ammonia.

The controller 88 includes a memory 90 and a processor 92. The processor 92 may include multiple microprocessors, one or more “general-purpose” microprocessors, one or more special-purpose microprocessors, and/or one or more application specific integrated circuits (ASICS), or some combination thereof. For example, the processor 92 may include one or more reduced instruction set (RISC) or complex instruction set (CISC) processors. The memory 90 may include a volatile memory, such as random access memory (RAM), and/or a nonvolatile memory, such as read-only memory (ROM). The memory 90 may store a variety of information and may be used for various purposes. For example, the memory 90 may store processor-executable instructions (e.g., firmware or software) for the processor 92 to execute, such as instructions for controlling the valves 78 and 80, and the valve 82. The memory 90 and/or the processor 92, or an additional memory and/or processor, may be located in any suitable portion of the implement 10 or, in some embodiments, a work vehicle towing the implement 10.

In certain embodiments, the controller 88 may be configured to increase the flowrate of the liquid through the additional liquid injection conduit 40 and/or the liquid injection conduit 41 based on the soil moisture value falling below a low threshold soil moisture value. In this manner, more liquid may be injected into the soil (e.g., in the trench) to form more ammonia solution, thereby reducing dissipation of the anhydrous ammonia in the air. Additionally or alternatively, the controller 88 may be configured to decrease the flowrate of the liquid through the additional liquid injection conduit 40 and/or the liquid injection conduit 41 based on the soil moisture value exceeding a high threshold soil moisture value. In this manner, less liquid may be injected into the soil (e.g., in the trench) when the soil moisture value (e.g., soil moisture content) is high, thereby reducing the amount of liquid used.

In certain embodiments, the controller 88 may be configured to increase the flowrate of the anhydrous ammonia through the anhydrous ammonia application conduit 44 based on the estimated soil moisture value exceeding a high threshold soil moisture value. In this manner, more anhydrous ammonia may be disposed in the soil when the soil moisture value is high. In response to increasing the amount of anhydrous ammonia disposed in the soil, the moisture of the soil may decrease as the additional anhydrous ammonia draws the moisture from the soil. Additionally or alternatively, the controller 88 may be configured to decrease the flowrate of the anhydrous ammonia through the anhydrous ammonia application conduit 44 based on the estimated soil moisture value falling below a low threshold soil moisture value. In this manner, less anhydrous ammonia may be disposed in the soil, thereby decreasing the amount of moisture that reacts with the anhydrous ammonia to form the ammonia solution.

In certain embodiments, the controller 88 may be configured to control the flowrate of the liquid and/or the flowrate of the anhydrous ammonia based on a sensed ground speed of the agricultural implement 10. For example, the controller 88 may be configured to decrease the flowrate of the liquid and/or the anhydrous ammonia in response to a decrease in the sensed ground speed of the agricultural implement 10. Additionally or alternatively, the controller 88 may be configured to increase the flowrate of the liquid and/or the anhydrous ammonia in response to an increase in the sensed ground speed of the agricultural implement 10. In this manner, a substantially consistent volume of the liquid and/or the anhydrous ammonia may be applied to the soil irrespective of the ground speed of the agricultural implement 10.

In certain embodiments, the controller 88 may be configured to control the flowrate of the liquid and/or the anhydrous ammonia based on a sensed width and/or a sensed depth of the trench formed by the coulter disc 28. For example, the controller 88 may be configured to increase the flowrate of the liquid and/or the anhydrous ammonia based on signal(s) (e.g., from trench sensor(s)) indicative of the trench having a large width and/or a large depth. Additionally or alternatively, the controller 88 may be configured to decrease the flowrate of the liquid and/or the anhydrous ammonia based on signal(s) indicative of the trench having a small width and/or a small depth.

In certain embodiments, the liquid flowrate may be controlled by controlling the valve 78 to reduce a difference (e.g., error) between the flowrate of the liquid (e.g., as determined based on feedback from the liquid flow sensor 72) and the target flowrate of the liquid through the additional liquid injection conduit 40 and/or the liquid injection conduit 41. For example, the controller 88 may be configured to control the valve 78 via a proportional-integral-derivative (PID) control process, which may use the flowrate of the liquid (e.g., as determined based on feedback from the liquid flow sensor 72) as feedback. Additionally or alternatively, the anhydrous ammonia flowrate may be controlled by controlling the valve 80 to reduce a difference (e.g., error) between the flowrate of the anhydrous ammonia (e.g., as determined based on feedback from the anhydrous ammonia flow sensor 74) and the target flowrate of the anhydrous ammonia through the anhydrous ammonia application conduit 44. For example, the controller 88 may be configured to control the valve 80 via a proportional-integral-derivative (PID) control process, which may use the flowrate of the anhydrous ammonia (e.g., as determined based on feedback from the anhydrous ammonia flow sensor 74) as feedback.

In certain embodiments, the controller 88 may be configured to control a pressure of the liquid within the additional liquid injection conduit 40 and/or the liquid injection conduit 41 based on the determined soil moisture. For example, the controller 88 may be configured to increase the pressure of the liquid within the additional liquid injection conduit 40 and/or the rearward liquid injection conduit based on the determine soil moisture value falling below a low threshold soil moisture value. In this manner, the liquid may be injected into the soil (e.g., at the trench) at a higher velocity. Additionally or alternatively, the controller 88 may be configured to decrease the pressure of the liquid within the additional liquid injection conduit 40 and/or the liquid injection conduit 41 based on the determined soil moisture value exceeding a high threshold soil moisture value. In this manner, the liquid may be injected into the soil (e.g., at the trench formed by the coulter disc 28) at a lower velocity.

In certain embodiments, the controller 88 may be configured to control a pressure of the anhydrous ammonia within the anhydrous ammonia application conduit 44 based on the determined soil moisture. For example, the controller 88 may be configured to increase the pressure of the anhydrous ammonia within the anhydrous ammonia application conduit 44 based on the determined soil moisture value exceeding a high threshold soil moisture value. In this manner, the anhydrous ammonia may be applied to the soil (e.g., at the trench) at a higher velocity. Additionally or alternatively, the controller 88 may be configured to decrease the pressure of the anhydrous ammonia within the anhydrous ammonia application conduit 44 based on the determined soil moisture value falling below a low threshold soil moisture value. In this manner, the anhydrous ammonia may be applied to the soil (e.g., at the trench formed by the coulter disc 28) at a lower velocity.

In certain embodiments, at least one nozzle (e.g., both nozzles 46 and 48) may include several configurations corresponding to different dispersion patterns of the liquid/anhydrous ammonia. For example, at least one nozzle (e.g., each nozzle) may include a narrow-spread dispersion configuration (e.g., setting), a medium-spread dispersion configuration (e.g., setting), a wide-spread dispersion configuration (e.g., setting), or a combination thereof. In certain embodiments, the controller 88 may be configured to adjust (e.g., via actuator(s)) the configurations (e.g., dispersion) of at least one of the nozzles (e.g., nozzles 46, 47, and 48) based on one or more factors, which may include a determined width of the trench formed by the coulter disc 28, the soil moisture value determined based on feedback from the soil moisture sensor 76, a ground velocity of the agricultural implement 10, or a combination thereof.

In certain embodiments, the controller 88 may be configured to change the configurations of the nozzles (e.g., nozzles 46, 47, and 48) while concurrently activating the valve 82. For example, the controller 88 may be configured to change the configuration of one nozzle from a configuration configured to inject liquid to a configuration configured to apply anhydrous ammonia, and the controller 88 may be configured to change the configuration of the other nozzle from a configuration configured to apply anhydrous ammonia to a configuration configured to inject liquid. In this manner, each nozzle may be configured to output the material flowing through the respective outlet passage.

In certain embodiments, the controller 88 may be configured to control the valves 78 and 80, the valve 82, or a combination thereof, based on a signal received from an input device (e.g., user interface). For example, an input device may be configured to enable an operator of a vehicle towing the agricultural implement 10 to open and close each valve and/or activate the valve 82 via manually providing input to the input device (e.g., pressing a button on a user interface). In certain embodiments, the controller 88 may be configured to adjust the flowrate of the liquid, the flowrate of the anhydrous ammonia, the pressure of the liquid, the pressure of the anhydrous ammonia, or a combination thereof, based on one or more inputs received from the input device.

In certain embodiments, the controller 88 may be configured to activate the valve 82 based on the soil moisture (e.g., determined based on feedback from the soil moisture sensor 76). For example, the controller 88 may be configured to activate the valve 82 in response to the soil moisture value (e.g., determined based on feedback from the soil moisture sensor 76) exceeding a high threshold value or decreasing below a low threshold value. For example, if the soil moisture value exceeds a high threshold value, the controller may be configured to activate the valve 82 to dispose the liquid onto the soil on the front side 56 of the coulter disc 28.

In certain embodiments, the controller 88 may be configured to open and/or close one or more valves (e.g., valves 78 and 80) based on an action of the coulter disc 28 and/or the agricultural implement 10. For example, the controller 88 may be configured to close one or more valves in response to raising of the coulter disc 28 (e.g., for a headland turn, for transport of the agricultural implement, etc.). In this manner, the liquid and the anhydrous ammonia stored in the storage tanks 18 and 19, respectively, may be conserved when the coulter disc 28 is not forming a trench. In certain embodiments, the controller 88 may be configured to open one or more valves in response to lowering of the coulter disc 28 (e.g., to a working position). Additionally or alternatively, the controller 88 may be configured to close one or more valves in response to stopping of the agricultural implement 10. In certain embodiments, the controller 88 may be configured to open one or more valves in response to initiation of movement of the agricultural implement 10.

In certain embodiments, the controller 88 may be configured to open and/or close the liquid injection valve 78 and/or the anhydrous ammonia application valve 80 at set time interval(s). For example, the controller 88 may be configured to close the liquid injection valve 78 and/or the anhydrous ammonia application valve 80 for a duration of time (e.g., less than 1 second, less than 5 seconds, less than a minute, etc.) and open the liquid injection valve 78 and/or the anhydrous ammonia application valve 80 for a duration of time (e.g., less than 1 second, less than 5 seconds, less than a minute, etc.). In certain embodiments, the controller 88 may be configured to alternate between opening and closing the liquid injection valve 78 and the anhydrous ammonia application valve 80. For example, the controller 88 may be configured to close the liquid injection valve 78 while concurrently opening the anhydrous ammonia application valve 80 for a duration of time, or vice versa. In certain embodiments, the time interval during which the liquid injection valve 78 and/or the anhydrous ammonia valve 80 remains opened and/or closed may be adjustable (e.g., via the user interface).

In certain embodiments, the controller 88 may be configured to activate the valve 82 for a time interval, such that the additional liquid injection conduit 40 becomes fluidly coupled to the liquid injection conduit 41 for a duration of time (e.g., less than 1 second, less than 5 seconds, less than a minute, etc.). In certain embodiments, the duration of time for which the valve 82 is activated is adjustable (e.g., via a user interface).

In certain embodiments, the controller 88 may be configured to change the configuration(s) of the liquid injection nozzles 46 and 47 and/or the anhydrous ammonia application nozzle 48 (e.g., via controlling actuator(s)) for a duration of time (e.g., less than 1 second, less than 5 seconds, less than a minute, etc.). For example, the controller 88 may be configured to change the configuration of at least one of the nozzles 46, 47 and/or 48 to a wide-spread configuration for a duration of time before reverting to a narrow-spread configuration, or vice versa. In certain embodiments, the duration of time for which the configuration of the nozzle(s) is changed is adjustable (e.g., via a user interface).

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform] ing [a function] . . . ” or “step for [perform] ing [a function] . . . ”, it is intended that such elements are to be interpreted under 35 U.S.C. 112 (f). However, for any claims containing elements designated in any other manner, it is intended that such elements are not to be interpreted under 35 U.S.C. 112 (f).

1. An agricultural implement comprising:
a ground engaging tool;
a liquid injection system comprising a liquid injection conduit and a liquid injection outlet passage, wherein the liquid injection outlet passage is fluidly coupled to the liquid injection conduit, and the liquid injection outlet passage is configured to output a jet of a liquid toward soil to inject the liquid into the soil at a liquid location behind the ground engaging tool relative to a direction of travel of the agricultural implement; and
an anhydrous ammonia application system comprising an anhydrous ammonia application conduit and an anhydrous ammonia application outlet passage, wherein the anhydrous ammonia application outlet passage is fluidly coupled to the anhydrous ammonia application conduit, and the anhydrous ammonia application outlet passage is configured to apply the anhydrous ammonia to the soil at an anhydrous ammonia location behind the ground engaging tool relative to the direction of travel of the agricultural implement.

2. The agricultural implement of claim 1, wherein the liquid location is disposed behind the anhydrous ammonia location.

3. The agricultural implement of claim 2, wherein the liquid injection system comprises an additional liquid injection outlet passage disposed in front of the ground engaging tool.

4. The agricultural implement of claim 1, wherein an anhydrous ammonia central axis of the anhydrous ammonia application outlet passage is directed to the anhydrous ammonia location of a field, and a liquid central axis of the liquid injection outlet passage is directed to the liquid location of the field.

5. The agricultural implement of claim 1, comprising a valve configured to:
adjust a flowrate associated with the jet of the liquid;
adjust a pressure associated with the jet of the liquid;
or a combination thereof.

6. The agricultural implement of claim 1, comprising a nozzle configured to adjust a jet spread rate associated with the jet of the liquid.

7. A control system comprising:
a soil moisture sensor configured to output a first signal indicative of a soil moisture value of a field; and
a controller comprising:
a memory configured to store instructions; and
one or more processors, wherein the controller is configured to:
receive the first signal from the soil moisture sensor;
determine an estimated soil moisture value based on the first signal; and
control an anhydrous ammonia flowrate, a liquid flowrate, or a combination thereof based on the estimated soil moisture value.

8. The control system of claim 7, comprising:
a liquid injection sensor configured to output a second signal indicative of a flowrate of a liquid through a liquid injection conduit; and
an anhydrous ammonia application sensor configured to output a third signal indicative of a flowrate of anhydrous ammonia in an anhydrous ammonia conduit.

9. The control system of claim 8, wherein the controller is configured to:
receive the second signal from the liquid injection sensor;
determine an estimated flowrate of the liquid based on the second signal;
receive the third signal from the anhydrous ammonia application sensor;
determine an estimated flowrate of the anhydrous ammonia based on the third signal;
determine a commanded flowrate of the liquid, a commanded flowrate of the anhydrous ammonia, or a combination thereof, based on the first signal; and
control a liquid injection valve of the liquid injection conduit based on the estimated flowrate and the commanded flowrate of the liquid, control an anhydrous ammonia application valve of the anhydrous ammonia conduit based on the estimated flowrate and the commanded flowrate of the anhydrous ammonia, or a combination thereof.

10. The control system of claim 9, wherein the controller is configured to:
increase the commanded flowrate of the liquid based on the estimated soil moisture value falling below a low threshold soil moisture value;
decrease the commanded flowrate of the liquid based on the estimated soil moisture value exceeding a high threshold soil moisture value;
or a combination thereof.

11. The control system of claim 10, wherein the controller is configured to:
increase the commanded flowrate of the anhydrous ammonia based on the estimated soil moisture value exceeding the high threshold soil moisture value;
decrease the commanded flowrate of the anhydrous ammonia based on the estimated soil moisture value falling below the low threshold soil moisture value;
or a combination thereof.

12. The control system of claim 9, wherein controlling the liquid injection valve comprises reducing a first difference between the estimated flowrate and the commanded flowrate of the liquid, wherein controlling the anhydrous ammonia application valve comprises reducing a second difference between the estimated flowrate and the commanded flowrate of the anhydrous ammonia.

13. An agricultural implement comprising:
a ground engaging tool;
a liquid injection system comprising a liquid injection conduit and a liquid injection outlet passage, wherein the liquid injection outlet passage is fluidly coupled to the liquid injection conduit, and the liquid injection outlet passage is configured to output a jet of the liquid toward soil to inject the liquid into the soil at a liquid location behind the ground engaging tool relative to a direction of travel of the agricultural implement;
an anhydrous ammonia application system comprising an anhydrous ammonia application conduit and an anhydrous ammonia application outlet passage, wherein the anhydrous ammonia application outlet passage is configured to apply the anhydrous ammonia to the soil at an anhydrous ammonia location behind the ground engaging tool relative to the direction of travel of the agricultural implement; and
a control system comprising:
a soil moisture sensor configured to output a first signal indicative of a soil moisture value of a field; and
a controller comprising:
a memory configured to store instructions; and
one or more processors, wherein the controller is configured to:
receive the first signal from the soil moisture sensor:
determine an estimated soil moisture value based on the first signal; and
control an anhydrous ammonia flowrate, a liquid flowrate, or a combination thereof based on the estimated soil moisture value.

14. The agricultural implement of claim 13, wherein the liquid location is disposed behind the anhydrous ammonia location.

15. The agricultural implement of claim 13, comprising:
a liquid injection sensor configured to output a second signal indicative of a flowrate of a liquid through the liquid injection conduit; and
an anhydrous ammonia application sensor configured to output a third signal indicative of a flowrate of anhydrous ammonia in an anhydrous ammonia conduit.

16. The agricultural implement of claim 15, wherein the controller is configured to:
receive the second signal from the liquid injection sensor;
determine an estimated flowrate of the liquid based on the second signal;
receive the third signal from the anhydrous ammonia application sensor;
determine an estimated flowrate of the anhydrous ammonia based on the third signal;
determine a commanded flowrate of the liquid, a commanded flowrate of the anhydrous ammonia, or a combination thereof, based on the first signal; and
control a liquid injection valve of the liquid injection conduit based on the estimated flowrate and the commanded flowrate of the liquid, control an anhydrous ammonia application valve of the anhydrous ammonia conduit based on the estimated flowrate and the commanded flowrate of the anhydrous ammonia, or a combination thereof.

17. The agricultural implement of claim 13, comprising a valve configured to:
adjust a flowrate associated with the jet of the liquid;
adjust a pressure associated with the jet of the liquid;
or a combination thereof.

18. The agricultural implement of claim 13, wherein an anhydrous ammonia central axis of the anhydrous ammonia application outlet passage is directed to the anhydrous ammonia location of the field, and a liquid central axis of the liquid injection outlet passage is directed to the liquid location of the field.

19. The agricultural implement of claim 13, wherein an additional liquid injection outlet passage is disposed in front of the ground engaging tool.

20. The agricultural implement of claim 19, comprising a valve configured to selectively couple the liquid injection conduit to the additional liquid injection outlet passage.
